(19) United States
(12) Patent Application Publication
(10) Pub. No.: US 2010/0316420 A1
(43) Pub. Date: Dec. 16, 2010

(54) IMAGE-SUPPORTING MEMBER AND IMAGE-FORMING APPARATUS

(75) Inventor: Tomohide MORI, Hachioji-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/815,604

(22) Filed: Jun. 15, 2010

(30) Foreign Application Priority Data
Jun. 16, 2009 (JP) 2009-143243

(51) Int. Cl. G03G 15/01

(52) U.S. Cl. 399/302

(57) ABSTRACT

An image-supporting member, having at least one thin film layer on an outer circumferential surface of the image-supporting member,
wherein an uppermost surface thin film layer contains a thick film region and a thin film region, a predetermined image is formed by the thick film region and the thin film region, and a thickness d₁ (nm) of the thick film region and a thickness d₂ (nm) of the thin film region satisfy the following relational expressions (1) and (2);

50 nm≦d₁−d₂≦950 nm (1)

20 nm≦d₂<d₁≦1000 nm (2)

This application is based on application(s) No. 2009-143243 filed in Japan, the contents of which are hereby incorporated by reference.

### BACKGROUND OF THE INVENTION

1. Field of the Invention

The present invention relates to an image-supporting member such as an intermediate transfer member and a photosensitive member, and an image-forming apparatus such as a monochrome or full-color electrophotographic copying machine, a printer, a facsimile machine and a complex machine having these functions.

2. Description of the Related Art

In a full color image-forming apparatus using an intermediate transfer system, a plurality of toner images which have been formed on photosensitive members on color basis are transferred onto an intermediate transfer belt and superimposed. Then, the superimposed images are transferred collectively onto a recording medium such as a sheet of paper to give a color image. The transfer from the photosensitive members onto the intermediate transfer belt is referred to as a “primary transfer” while the transfer from the intermediate transfer belt onto the recording medium is referred to as a “secondary transfer”. In these transfer processes, a bias is applied to a transfer roller or the like so as to generate an electric field, thereby transferring the toner images.

In the full color image-forming apparatus as described above, four color toner images need to be superimposed at high accuracy. Therefore, color shifts are required to be prevented. Accordingly, a degree of color shift due to thickness nonuniformity of the intermediate transfer belt is previously stored for each color to correct the exposure timing (Japanese Patent Application Laid-Open No. 2001-242674). A position where an image is formed on the belt need to be accurately detected in order to correct such color shift. Therefore, a home position of the belt has to be detected. As a method of detecting the home position, a method of detecting the home position with a transmission sensor by opening a hole for detection to an edge of the belt or a method of detecting the home position with a reflection sensor by pasting a reflective material to an edge of the belt is generally used.

However, the method in which a hole is opened has a disadvantage that the strength of the belt is reduced. The method in which a reflective material is pasted has also a disadvantage that the detection cannot be performed if the reflective material falls off or is contaminated. Further, in the both methods, the width of the belt needs to be larger in order to provide the hole or the reflective material for detection on the edge of the belt. A dedicated sensor for detection needs to be further provided. These result in the increase of the apparatus in size.

Generally, indications such as instructions for use and product numbers for various members arranged in an image-forming apparatus are pasted to wall faces of a housing in the apparatus or side faces of the members. In this case, the indications such as instructions for use and product numbers have been previously printed on paper sheets or films. For example, an instruction of an installing direction of a member such as an intermediate transfer member or a photosensitive member or a warning “DO NOT TOUCH”, which has been previously printed on paper sheets or films, is pasted to wall faces of the housing in the apparatus or side faces of the members. The product numbers of members or the like, which have been previously printed on paper sheets or films, are pasted to side faces of the members. However, it was troublesome to paste the printed matters of such indications. In addition, the printed matters are contaminated by the toner powder smoke in the apparatus with the lapse of time. Therefore, it was difficult to keep the printed matters pasted thereto for a long period of time.

### BRIEF SUMMARY OF THE INVENTION

According to the invention, there is provided an image-supporting member having at least one thin film layer on an outer circumferential surface of the image-supporting member, characterized in that an uppermost surface thin film layer has a thick film region and a thin film region, a predetermined image is formed by the thick film region and the thin film region, and a thickness d₁ (nm) of the thick film region and a thickness d₂ (nm) of the thin film region satisfy the following relational expressions (1) and (2);

50 nm≦d₁−d₂≦950 nm (1)

20 nm≦d₂<d₁≦1000 nm (2), and

an image-forming apparatus including the image-supporting member.

### BRIEF DESCRIPTION OF THE DRAWINGS

FIG. 1 is a schematic configuration view showing an example of an image-forming apparatus according to a first aspect of the invention.

FIG. 2 is a schematic configuration view showing an example of an intermediate transfer belt according to the first aspect (a second aspect) of the invention.

FIG. 3 is a schematic view showing an example of an outer circumferential surface of the intermediate transfer belt according to the first aspect of the invention.

FIG. 4 is a schematic configuration view showing an example of the image-forming apparatus according to the second aspect of the invention.

FIG. 5 is a schematic view for explaining an arrangement relationship between a photosensor and an intermediate transfer belt in the second aspect of the invention.

FIG. 6 is a schematic view showing an example of an outer circumferential surface of the intermediate transfer belt according to the second aspect of the invention.

FIG. 7 is a graph showing an example of change in film thickness in the circumferential direction in the intermediate transfer belt of FIG. 6.

FIG. 8 is a graph showing an example of change in sensor output in the circumferential direction in the intermediate transfer belt of FIG. 6.

FIG. 9A is a schematic view showing an example of the outer circumferential surface of the intermediate transfer belt according to the second aspect of the invention.

FIG. 9B is a graph showing an example of change in film thickness in the circumferential direction in the intermediate transfer belt of FIG. 9A.

FIG. 9C is a graph showing an example of change in sensor output in the circumferential direction in the intermediate transfer belt of FIG. 9A.

FIG. 10 is a schematic view schematically showing optical interferences when the intermediate transfer belt is irradiated with light (main wavelength λ) from a light source unit of the photosensor to the intermediate transfer belt in the second aspect in the invention.

FIG. 11 is a graph for explaining a reflective function R(d) indicating a relationship between a reflectivity R of the outer circumferential surface of the intermediate transfer belt with respect to the light having a light-emitting main wavelength λ and a thickness d (nm) of an uppermost surface thin film layer of the intermediate transfer belt in the second aspect of the invention.

FIG. 12 is a view explaining an apparatus for manufacturing an inorganic oxide layer.

FIG. 13 is a graph showing a relationship between a transfer ratio and a film thickness d (nm) of the uppermost surface thin film layer in the intermediate transfer belt in an experimental example A.

FIG. 14 is a graph of a reflective function R(d) obtained in an experimental example B.

### DETAILED DESCRIPTION OF THE INVENTION

According to a first aspect of the invention, there is provided an image-supporting member having at least one thin film layer on an outer circumferential surface of the image-supporting member, characterized in that an uppermost surface thin film layer has a thick film region and a thin film region, a predetermined image is formed by the thick film region and the thin film region, and a thickness d₁ (nm) of the thick film region and a thickness d₂ (nm) of the thin film region satisfy the following relational expressions (1) and (2);

50 nm≦d₁−d₂≦950 nm (1)

20 nm≦d₂<d₁≦1000 nm (2), and

an image-forming apparatus including the image-supporting member.

### First and Second Aspects of the Invention

Image-forming apparatuses according to the first and second aspects of the invention are equipped with an image-supporting member. As the image-supporting member in the first and second aspects of the invention, the one that has at least one thin film layer at the outer circumferential surface thereof and transports toner (images) on the outer circumferential surface is preferable. Specific examples of the image-supporting member are a so-called intermediate transfer member, a photosensitive member, and the like. The image-supporting member may have a belt shape or a drum shape. Hereinafter, a case where the image-supporting member is an intermediate transfer belt is described in detail. However, if the image-supporting member having a drum shape, or other image-supporting members is used, it is clearly understood that objects of the invention can be achieved in accordance with the following description.

First Aspect of the Invention

The image-forming apparatus according to the first aspect of the invention is described in detail.

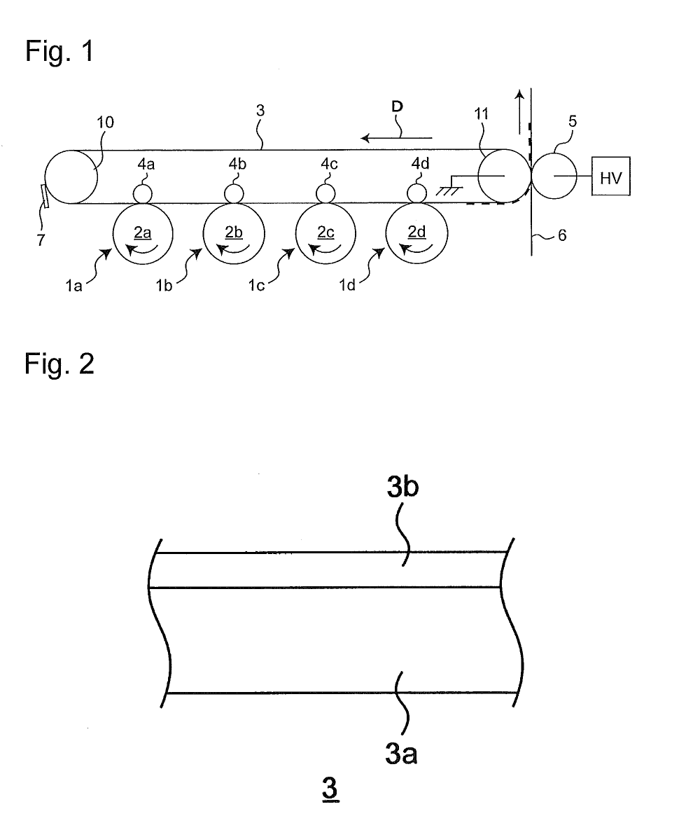

FIG. 1 is a schematic configuration view showing an example of the image-forming apparatus according to the first aspect of the invention. The image-forming apparatus in FIG. 1 is a tandem type full-color image-forming apparatus having photosensitive members which are provided in each developing unit for each color. The developing units form toner images on the photosensitive members. The image-forming apparatus may have other configurations as long as the image-forming apparatus has an intermediate transfer belt which will be described later. For example, a four cycle type full-color image-forming apparatus having developing units for each color with respect to one photosensitive member may be employed.

In the tandem type full-color image-forming apparatus as shown in FIG. 1, at least a charging device, an exposing device, a developing device, a cleaning device (all components are not shown), and the like are generally arranged around each of the photosensitive members (2a, 2b, 2c, 2d) in each of the developing units (1a, 1b, 1c, 1d). The developing units (1a, 1b, 1c, 1d) are arranged in parallel with an intermediate transfer belt 3 which is stretched by at least two tension rollers (10, 11) in a tension manner. Toner images formed on the surfaces of the photosensitive members (2a, 2b, 2c, 2d) in the developing units are primarily transferred onto the intermediate transfer belt 3 using primary transfer rollers (4a, 4b, 4c, 4d) respectively. Then, the toner images are superimposed on one another on the intermediate transfer belt 3 so as to form a full color image. The full color image transferred onto the surface of the intermediate transfer belt 3 is secondarily transferred collectively onto a recording medium 6 such as a paper using a secondary transfer roller 5. Thereafter, the full color image is passed through a fixing device (not shown) so as to obtain a full color image on the recording medium. Remaining toners on the intermediate transfer belt without being transferred are removed by a cleaning device 7.

The intermediate transfer belt 3 is to support toner images, which are formed on the photosensitive members in the developing units, on the surface of the intermediate transfer belt 3 by the primary transfer so as to transport the toner images for the secondary transfer.

In the first aspect of the invention, the intermediate transfer belt 3 has at least one thin film layer at the outer circumferential surface thereof. For example, the intermediate transfer belt 3 may have a single layer structure in which one thin film layer 3b is formed on a substrate 3a as shown in FIG. 2. Alternatively, the intermediate transfer belt 3 may have a multilayer structure in which one or more other layers are formed between the substrate 3a and the thin film layer 3b. In the present specification, a thin film layer of the single layer type intermediate transfer belt and a thin film layer which is an uppermost surface of the multilayer type intermediate transfer belt are collectively referred to as an uppermost surface thin film layer.

The substrate 3a is not particularly limited and preferably has a volume resistivity in the range of 10⁶ to 10¹² Ω·cm and usually has a seamless belt shape. For example, the substrate 3a is obtained by dispersing a conductive filler such as carbon or by containing an ionic conductive material in a resin material such as polycarbonate (PC), polyimide (PI), polyamide imide (PAI), polyphenylene sulfide (PPS). The thickness of the substrate 3a is set to about 50 to 500 μm.

The uppermost surface thin film layer 3b has a releasability to toner (toner-releasing property). For example, an inorganic thin film layer such as an inorganic oxide layer is used for the uppermost surface thin film layer 3b.

The inorganic oxide layer preferably includes one or more oxide selected from silicon oxide, aluminum oxide, titanium oxide and zinc oxide, particularly silicon oxide.

The uppermost surface thin film layer 3b has a thick film region at which the thickness of the film is relatively thick and a thin film region at which the thickness of the film is relatively thin. A predetermined image (emboss image) is formed by the thick film region and the thin film region. In the present specification, the emboss image refers to an image appeared by concavity and convexity of the surface of uppermost surface thin film layer based on differences in thickness between the thick film region and the thin film region. For example, the emboss image may be a raised image appeared by the thick film region in the thin film region or a depressed image appeared by the thin film region in the thick film region.

A thickness d₁ (mm) of the thick film region and a thickness d₂ (nm) of the thin film region satisfy the following expressions (1) and (2);

50 nm≦d₁−d₂≦950 nm (1)

20 nm≦d₂<d₁≦1000 nm (2)

There is little difference in toner image-transferring properties between the thick film region and the thin film region so that a toner image on a recording medium is not adversely affected. Therefore, both the thick film region and the thin film region can be mixedly formed on the outer circumferential surface of the intermediate transfer belt. In addition, since the thick film region is different in thickness from the thin film region, the reflectivity with respect to natural light becomes different between the thick film region and the thin film region based on the difference in thickness. This makes it possible to visually distinguish the thick film region and the thin film region from each other easily. Therefore, the toner image on the recording medium is not adversely affected even though a predetermined image (emboss image) is formed in the thick film region and the thin film region by utilizing the difference in thickness and the difference in reflectivity caused by the difference in thickness with respect to natural light in the uppermost surface thin film layer. Further, the thick film region and the thin film region are formed on the image-supporting surface which is always cleaned by a cleaning member for collecting the remaining toners without being transferred. Accordingly, there is no difficulty to read the thick film region and the thin film region due to the toner powder smoke. If images such as instructions for use, symbols and product numbers for various members arranged in the image-forming apparatus, for example, are formed as emboss images formed by the thick film region and the thin film region, printed matters need not to be attached. This makes it possible to continuously display the images for a long period of time easily. If a value of d₁−d₂ is too small, a significant difference in reflectivity with respect to natural light is not generated between the thick film region and the thin film region. Therefore, an obtained emboss image is not obviously formed and it is difficult to display the emboss image. In contrast, if a value of d₁−d₂ is too large, cracking or stripping of the uppermost surface thin film layer at boundaries between the thick film region and the thin film region is caused with the lapse of time. If a value of d₂ is too small, cracking or stripping due to abrasion is caused in the thin film region with the lapse of time. If a value of d₁ is too large, cracking or stripping due to flexion is caused in the thick film region with the lapse of time.

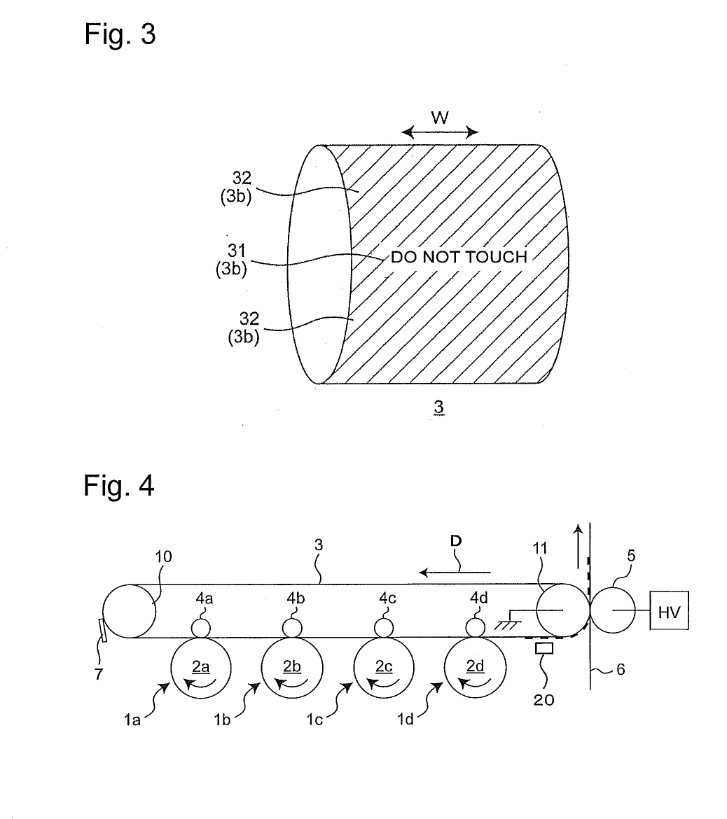

An image appeared as an emboss image in the first aspect of the invention is not particularly limited and includes, for example, images such as a character image, a geometric image, a symbol and a pattern. To be more specific, in order to draw users' attention so as not to touch the outer circumference surface of the intermediate transfer belt, a character image “DO NOT TOUCH” or the like can be displayed as a raised image as the thick film regions 31 in the thin film regions 32 on the uppermost surface thin film layer 3b, as shown in FIG. 3. FIG. 3 is a schematic view showing an example of the outer circumferential surface of the intermediate transfer belt for explaining a configuration such as arrangements of the thick film regions 31 and the thin film regions 32. In FIG. 3, a reference symbol W indicates a width direction of the intermediate transfer belt. A predetermined image may be formed of a depressed image as the thin film regions in the thick film regions.

The above relational expression (1) is preferably the following expression (1′) from the viewpoint to display and form emboss images more clearly by the thick film region and the thin film region:

80 nm≦d₁−d₂≦500 nm (1′).

The above relational expression (2) is preferably the following expression (2′) from the viewpoint to prevent cracking and stripping of the thick film region or/and the thin film region more effectively:

50 nm≦d₂≦500 nm, 130 nm≦d₁≦600 nm (2′).

The thick film region 31 and the thin film region 32 can be visually distinguished easily based on the difference in thickness and the difference in reflectivity with respect to natural light as described above. The thickness d₁ (nm) of the thick film region and the thickness d₂ (nm) of the thin film region can be obtained by measuring the thicknesses in predetermined regions distinguished visually. To be more specific, as each of the thickness d₁ (nm) of the thick film region and the thickness d₂ (nm) of the thin film region, an average value of thicknesses at twenty points in the predetermined regions of each of the thick film region and the thin film region is used. The thickness is measured by a thin film thickness analyzer (manufactured by Mamiya-OP Co., Ltd.).

The thickness is uniform at every portion in each of the thick film region 31 and the thin film region 32.

The thicknesses at the arbitrary twenty points in the thick film region 31 are in a range of the average value thereof ±5 nm.

The thicknesses at the arbitrary twenty points in the thin film region 32 are also in a range of the average value thereof ±5 nm.

Toner images are formed on the photosensitive members (2a, 2b, 2c, 2d) based on electrostatic latent images formed on the surface thereof. The photosensitive members are not particularly limited as long as the photosensitive members can be mounted on a conventional electrophotographic image-forming apparatus, and generally include a organic photosensitive layer.

The primary transfer rollers 4 (4a, 4b, 4c, 4d) are arranged on the opposite side to the photosensitive members 2 with respect to the intermediate transfer belt 3. The primary transfer rollers 4 (4a, 4b, 4c, 4d) pressurize the intermediate transfer belt 3 while a bias is applied to each of the primary transfer rollers 4 (4a, 4b, 4c, 4d) when desired. Therefore, the toner images carried on the surfaces of the photosensitive members 2 (2a, 2b, 2c, 2d) are primarily transferred onto the intermediate transfer belt 3.

When the bias is applied to each of the primary transfer rollers, a DC component having a reverse polarity to electrostatic charge polarity of the toner, for example, is applied. An absolute value of the DC component is in the range of 300 to 3000 V, in particular, 600 to 1500 V. The reverse polarity to the electrostatic charge polarity of the toner means +polarity when the toner is negatively chargeable, and −polarity when the toner is positively chargeable. An AC component may be superimposed in addition to the DC component on each of the primary transfer rollers.

A configuration of the primary transfer roller is not particularly limited. For example, a roller in which the surface of cored bar has a coated layer obtained by dispersing carbon or the like as a conductive material in EPDM, NBR or the like, a metal roller or the like can be used as the primary transfer roller.

The secondary transfer roller 5 is arranged on the opposite side to the tension roller 11 with respect to the intermediate transfer belt 3. The secondary transfer roller 5 pressurizes the intermediate transfer belt 3 carrying the toner images through the recording medium 6. Therefore, the toner images are secondarily transferred onto the recording medium 6. A bias is applied to the secondary transfer roller when desired to progress the secondary transfer.

A configuration of the secondary transfer roller is not particularly limited and preferably has an elastic layer. This is because the adhesion to the recording medium is to be ensured.

As a configuration of the secondary transfer roller having the elastic layer, a configuration in which the surface of cored bar has the elastic layer is exemplified. The cored bar made of a metal such as an iron or a stainless steel can be used.

The elastic layer has an Asker C hardness of 20° to 60°, in particular, 30° to 50°.

In the present specification, the Asker C hardness is a value measured with an Asker rubber hardness tester, Type C.

The elastic layer is formed with an elastic material such as ethylene-propylene-diene rubber (EPDM), nitrile-butadiene rubber (NBR), chloroprene rubber (CR), silicone rubber, and urethane rubber. In general, the elastic layer further contains a conductive material. For example, carbon or the like can be used as the conductive material.

A thickness of the elastic layer is generally in the range of 1 to 20 mm, in particularly, 3 to 10 mm.

The resistance of the secondary transfer roller is preferably 10⁵ to 10¹⁰Ω, particularly 10⁶ to 10⁸Ω from the viewpoint of ensuring the transferring property.

When a bias is applied to the secondary transfer roller, a DC component which has a reverse polarity to electrostatic charge polarity of the toner, for example, is applied. An absolute value of the DC component is in the range of 300 to 5000 V, in particular, 600 to 3000 V. An AC component may be superimposed in addition to the above DC component on the secondary transfer roller.

The tension rollers (10, 11) are not particularly limited, and may be, for example, a metal roller metal such as aluminum or iron. The tension rollers may be a roller having, on an outer circumferential surface of a cored bar, a coated layer obtained by dispersing a conductive powder material, carbon or the like in EPDM, NBR, urethane rubber, silicone rubber or the like, and having a resistance value adjusted to 1 10⁹ Ω·cm or less.

Other members and devices in the image-forming apparatus according to the first aspect of the invention such as the cleaning device 7, the charging device, the exposing device, the developing device and a cleaning device for a photosensitive member are not particularly limited. Known members and devices which have been conventionally used in the image-forming apparatus can be used.

For example, the developing device may be a developing device employing one-component developing system in which only toner is used or a developing device employing two-component developing system in which both toner and carrier are used.

Toner may contain toner particles manufactured by a wet method such as a polymerization method or a grinding method (dry method).

An average particle size of the toner is not particularly limited, and is preferably 7 μm or less, particularly 4.5 μm to 6.5 μm.

The electrostatic property of toner is also not particularly limited, and the toner may be positively chargeable or negatively chargeable.

Second Aspect of the Invention

The image-forming apparatus according to the second aspect of the invention is described. FIG. 4 is a schematic configuration view showing an example of the image-forming apparatus according to the second aspect of the invention. In FIG. 4, same reference numerals as those in FIG. 1 indicate the same contents as those in FIG. 1, unless otherwise specified.

The image-forming apparatus according to the second aspect of the invention is the same as the image-forming apparatus according to the first aspect of the invention except for the following points. The image-forming apparatus according to the second aspect of the invention has a photosensor 20 and the intermediate transfer belt 3 according to the first aspect of the invention in which the thicknesses of the thick film region and the thin film region forming an emboss image further satisfy the following relational expression (3) or (3′). Therefore, the same description as in the first aspect of the invention is not repeated in the second aspect of the invention unless otherwise specified.

To be more specific, the image-forming apparatus according to the second aspect of the invention has the photosensor 20 and the thickness d₁ (nm) of the thick film region 31 and the thickness d₂ (nm) of the thin film region 32 in the uppermost surface thin film layer of the intermediate transfer belt 3 satisfy the following relational expression (3) for a reflectivity function R(d) in addition to the relational expressions defined in the first aspect of the invention. The reflectivity function R(d) indicates a relationship between a reflectivity R on the outer circumferential surface of the intermediate transfer belt with respect to light from the photosensor and a thickness d (nm) of the uppermost surface thin film layer of the image-supporting member.

|R(d₁)−R(d₂)|≧0.5{Rₘₐₓ(d)−Rₘᵢₙ(d)} (3)

Preferably

|R(d₁)−R(d₂)|≧0.7{Rₘₐₓ(d)−Rₘᵢₙ(d)} (3′)

In the second aspect of the invention, the following effects can be also obtained in addition to the effects obtained in the first aspect of the invention.

In the second aspect of the invention, a difference in reflectivity of irradiation light of the photosensor 20 is sufficiently generated between the thick film region 31 and the thin film region 32. Therefore, the thick film region and the thin film region can be detected by utilizing the difference in reflectivity. That is to say, d₁, and d₂ are selected such that the difference in reflectivity between the thick film region 31 and the thin film region 32 is a predetermined value or more as defined in the above relational expressions (3) and (3′). This makes it possible to detect the thick film region 31 and the thin film region 32 by the photosensor. The positions of the thick film region 31 and the thin film region 32 are previously recognized so that a home position and a rotational speed of the intermediate transfer belt can be stably detected without increasing the apparatus in size. If the d₁, and d₂ do not satisfy the above relational expressions (3) and (3′), the difference in reflectivity is not sufficiently obtained between the thick film region 31 and the thin film region 32. Therefore, the thick film region 31 and the thin film region 32 cannot be satisfactorily detected by the photosensor.

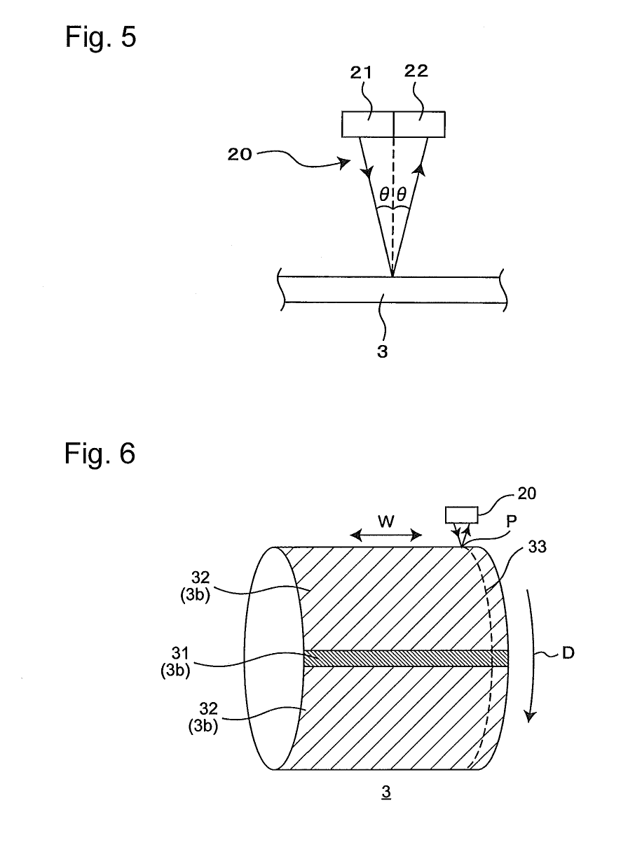

The photosensor 20 includes a light source unit 21 and a light receiving unit 22 as shown in FIG. 5, for example. The light source unit 21 emits a light having a main wavelength λ and irradiates the outer circumferential surface of the intermediate transfer belt 3 with light. The light receiving unit 22 receives reflection light reflected by the outer circumferential surface of the intermediate transfer belt 3. The light source unit 21 and the light receiving unit 22 are installed such that the incident angle of the light source unit 21 and the light receiving angle of the light receiving unit 22 are the same value θ. FIG. 5 is a schematic view showing an arrangement relationship between the photosensor and the intermediate transfer belt, being a cross-sectional configuration view perpendicular to a rotational direction (driving direction) D of the intermediate transfer belt in FIG. 4.

The photosensor 20 optically detects the reflectivity of the outer circumferential surface of the intermediate transfer belt at the time of color shift correction which is periodically performed, for example. Specifically, the light source unit 21 irradiates the outer circumferential surface of the intermediate transfer belt with light while the intermediate transfer belt is rotatably driven in a clean state where toner is not carried on the outer circumferential surface of the intermediate transfer belt. Then, the light receiving amount of the reflection light reflected is measured by the light receiving unit 22. The light receiving amount of the reflection light is obtained in the light receiving unit 22 as a voltage value output in accordance with the size of the light receiving amount. Therefore, the change in reflectivity is detected as a change in photosensor output value.

In the second aspect of the invention, the uppermost surface thin film layer 3b has the thick film region and the thin film region in the circumferential direction of the intermediate transfer belt. The wording of “the uppermost surface thin film layer 3b has the thick film region and the thin film region in the circumferential direction of the intermediate transfer belt” means that a trajectory (dashed line 33) drawn by a light irradiation point P from the photosensor 20 on the surface of the uppermost surface thin film layer 3b passes through one or more thick film regions 31 and one or more thin film regions 32, as shown in FIG. 6. The trajectory is drawn when the intermediate transfer belt 3 rotates and drives in the circumferential direction D. As shown in FIGS. 4 to 6, the photosensor 20 is fixedly arranged in the apparatus so as to detect the thick film region and the thin film region by the rotation and driving of the intermediate transfer belt 3 in the circumferential direction D. Therefore, even if the uppermost surface thin film layer has one or more thick film regions and one or more thin film regions, when the trajectory (dashed line 33) drawn by the light irradiation point P passes through only either the thick film region or the thin film region, the photosensor cannot detect change in reflectivity. Namely, the photosensor cannot detect the thick film region and the thin film region. Accordingly, the photosensor cannot detect a home position. FIG. 6 is a schematic view showing an example of the outer circumferential surface of the intermediate transfer belt for explaining the entire arrangement relationship between the photosensor and the intermediate transfer belt, and for explaining a configuration such as a size and an arrangement of the thick film region 31 and the thin film regions 32.

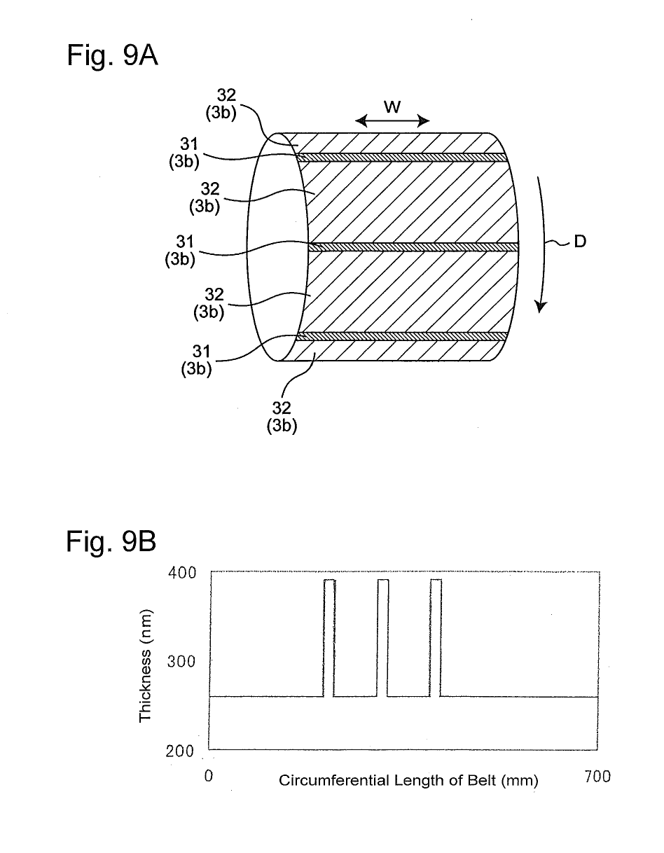

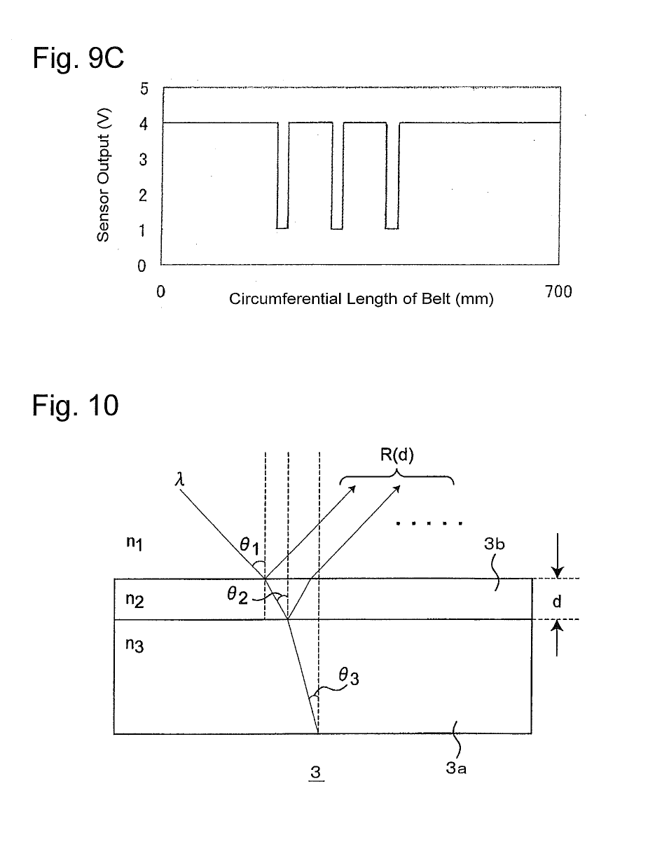

An image appeared as an emboss image by the thick film region 31 and the thin film region 32 in the second aspect of the invention is not particularly limited as long as the thick film region and the thin film region are formed in the circumferential direction of the intermediate transfer belt. For example, an image which is the same as the image appeared as an emboss image in the first aspect of the invention is included. From the viewpoint of simplification of film formation, a preferred image is an image formed over the whole length in the width direction as shown in FIGS. 6 and 9A.

In FIG. 6, the photosensor 20 is arranged relatively on the edge portion in the width direction W of the intermediate transfer belt 3. However, an arrangement of the photosensor 20 is particularly not limited as long as the trajectory (dashed line 33) drawn by the light irradiation point P passes through one or more thick film regions 31 and one or more thin film regions 32. For example, in FIG. 6, since the thick film region 31 and the thin film regions 32 are formed over the whole length in the width direction W, the photosensor 20 may be arranged on an arbitrary position in the width direction W of the intermediate transfer belt 3.

In FIG. 6, the thick film region 31 and the thin film regions 32 are formed over the whole length in the width direction W. However, the sizes of the thick film region 31 and the thin film regions 32 are not particularly limited as long as the trajectory (dashed line 33) drawn by the light irradiation point P passes through one or more thick film regions 31 and one or more thin film regions 32. For example, the thick film region and the thin film regions may be formed only at one edge portion or the center portion in the width direction W. In such case, the photosensor 20 is arranged such that the trajectory (dashed line 33) drawn by the light irradiation point P passes through the thick film region and the thin film regions. It is sufficient that the lengths of the thick film region 31 and the thin film regions 32 in the circumferential direction D are independently 5 mm or more, preferably 8 to 20 mm.

In FIG. 6, the thick film region 31 is formed in the thin film regions 32. However, the arrangement of the thick film region 31 and the thin film regions 32 are not particularly limited as long as the trajectory (dashed line 33) drawn by the light irradiation point P passes through one or more thick film regions 31 and one or more thin film regions 32. For example, the thin film region 32 may be formed in the thick film regions 31.

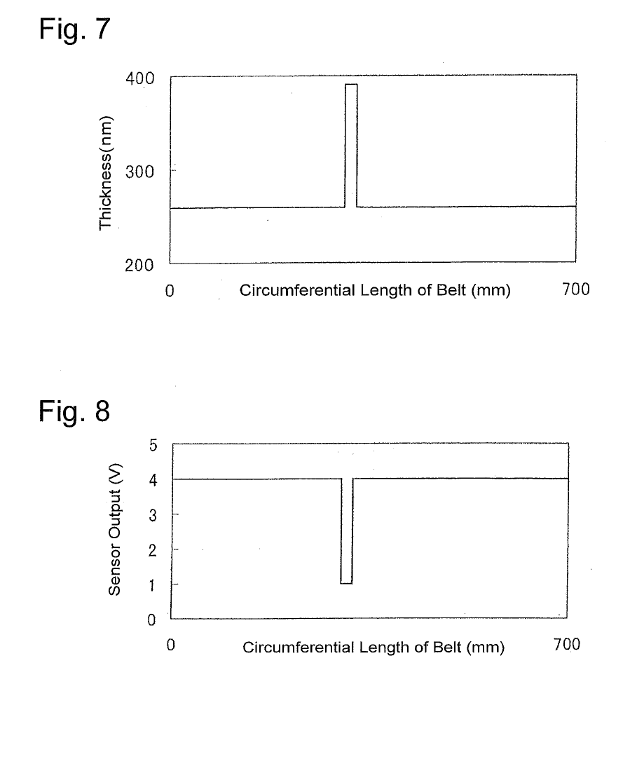

In the second aspect of the invention, positions of the thick film region 31 and the thin film regions 32 are previously recognized so that the thick film region 31 and the thin film regions 32 at the known positions in the circumferential direction are detected by the photosensor 20 based on the difference in reflectivity thereof. To be more specific, the photosensor 20 detects a sensor output as a reflectivity while rotation-driving the intermediate transfer belt. Therefore, the sensor output sufficiently changes at boundaries between the thick film region 31 and the thin film regions 32. FIG. 7 shows an example of the change in film thickness in the belt circumferential direction in the intermediate transfer belt 3 as shown in FIG. 6, and FIG. 8 shows an example of the change in sensor output in the belt circumferential direction. Since the positions of the thick film region 31 and the thin film regions 32 in the circumferential direction are known, the boundaries between the thick film region and the thin film regions can be easily detected by the change in sensor output. As a result, a home position of the intermediate transfer belt can be accurately detected.

FIG. 9A is a schematic view showing another example of the circumferential surface of the intermediate transfer belt. The intermediate transfer belt shown in FIG. 9A has the same configuration as that shown in FIG. 6 except that three thick film regions 31 are formed in the width direction W. FIG. 9B shows an example of the change in film thickness in the belt circumferential direction in the intermediate transfer belt shown in FIG. 9A, and FIG. 9C shows an example of the change in sensor output in the belt circumferential direction. The variation in the rotational speed due to the variation in the thickness of the intermediate transfer belt can be accurately detected by forming two or more thick film regions 31 and one or more thin film regions 32 or one or more thick film regions 31 and two or more thin film regions 32 in the circumferential direction D and detecting these regions by the photosensor. For example, at the time of measuring the change in sensor output as shown in FIG. 9C, the passage time between different two thick film regions is measured. This makes possible to accurately detect the rotational speed of the intermediate transfer belt from the measured passage time and the known distance between the different two thick film regions.

The thick film region 31 and the thin film region 32 according to the second aspect of the invention are the same as those according to the first aspect of the invention except that d₁ and d₂ according to the second aspect of the invention further satisfy the above relational expression (3) or (3′). For example, d₁ and d₂ can be measured by the same method as that in the first aspect of the invention. Further, the thickness uniformity of each of the thick film region 31 and the thin film region 32 in the second aspect of the invention is in the same range as in the first aspect of the invention.

In the relational expressions (3) and (3′), d indicates the thickness of the uppermost surface thin film layer.

R(d₁) indicates a reflectivity when the thickness of the uppermost surface thin film layer is d₁.

R(d₂) indicates a reflectivity when the thickness of the uppermost surface thin film layer is d₂.

Rₘₐₓ(d) indicates a maximum value of the reflectivity function R(d).

Rₘᵢₙ(d) indicates a minimum value of the reflectivity function R(d).

The reflectivity function R(d) is described in detail.

It is generally known that when the outer circumferential surface of the intermediate transfer belt having an uppermost surface thin film layer is irradiated with light, an optical interference is generated in reflection light. Therefore, the reflectivity periodically varies depending on the thickness of the uppermost surface thin film layer and is expressed by R(d). FIG. 10 is a schematic view showing a generation mechanism of the optical interference. Specifically, FIG. 10 schematically shows the optical interference when the intermediate transfer belt 3 is irradiated with light (main wavelength λ) from the light source unit of the photosensor. The interference is generated in the reflection light at least at an interface between an air layer (refractive index n₁) and the uppermost surface thin film layer 3b (refractive index n₂) and an interface between the uppermost surface thin film layer 3b (refractive index n₂) and the substrate 3a (refractive index n₃), as shown in FIG. 10. In the paper face of FIG. 10, the front surface and back surface direction are a driving direction of the intermediate transfer belt.

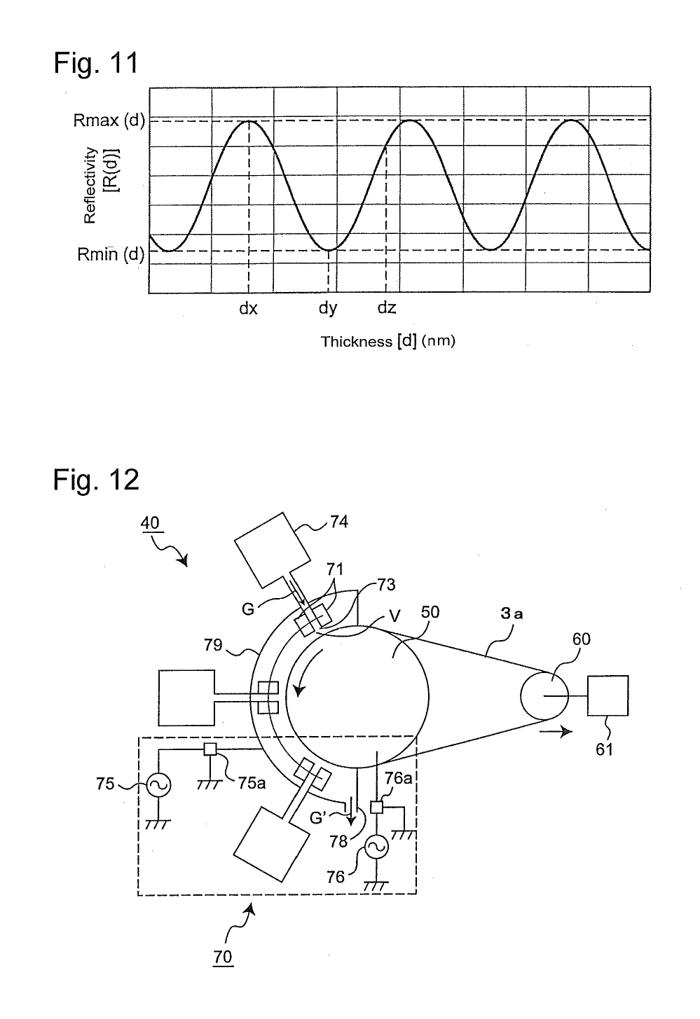

The reflectivity function R(d) indicates a relationship between a reflectivity R with respect to light having a light-emitting main wavelength λ of the outer circumferential surface of the intermediate transfer belt in a state where toner is not carried and a thickness d (nm) of the uppermost surface thin film layer of the intermediate transfer belt. The reflectivity function R(d) forms a waveform having a periodicity as shown in FIG. 11. In the second aspect of the invention, the thickness d₁ (nm) of the thick film region and d₂ (nm) of the thin film region in the uppermost surface thin film layer are selected so as to satisfy the above relational expression (3) or (3′) for the reflectivity function R(d). In FIG. 11, when R(dₓ)=Rₘₐₓ(d) R(d_{y})=Rₘᵢₙ(d), and R(d_{z})=0.8 {Rₘₐₓ(d)−Rₘᵢₙ(d)}+Rₘᵢₙ(d) are satisfied, if d_{y} is selected as d₁ and dₓ is selected as d₂, R(d₁)=Rₘᵢₙ(d) and R(d₂)=Rₘₐₓ(d) are satisfied. In this case, the following expression is satisfied and d₁ and d₂ satisfy the above relational expressions (3) and (3′):

|R(d₁)−R(d₂)|=1.0{Rₘₐₓ(d)−Rₘᵢₙ(d)}.

On the other hand, in FIG. 11, if d_{z}, is selected as d₁ and d_{y} is selected as d₂, R(d₁)=0.8 {Rₘₐₓ(d)−Rₘᵢₙ(d)}+Rₘᵢₙ(d) and R(d₂)=Rₘᵢₙ(d) are satisfied. In this case, the following expression is satisfied and d₁ and d₂ satisfy the above relational expressions (3) and (3′):

|R(d₁)−R(d₂)|=0.8{Rₘₐₓ(d)−Rₘᵢₙ(d)}.

The reflectivity function R(d) can be easily obtained by a matrix calculation using a matrix method.

For example, the reflectivity function R(d) can be expressed by the following expression when the intermediate transfer belt has a single layer structure in which one uppermost surface thin film layer 3b is formed on the substrate 3a:

$$R ( d ) = 0.5 \times ( \begin{matrix}\frac{{A}^{2} + {B}^{2} + 2 AB cos 2 δ}{1 + {A}^{2} + {B}^{2} + 2 AB cos 2 δ} + \\ \frac{{C}^{2} + {D}^{2} + 2 CD cos 2 δ}{1 + {C}^{2} + {D}^{2} + 2 CD cos 2 δ}\end{matrix} ) \\ A = \frac{{n}_{2} cos {θ}_{1} - {n}_{1} cos {θ}_{2}}{{n}_{2} cos {θ}_{1} + {n}_{1} cos {θ}_{2}} B = \frac{{n}_{3} cos {θ}_{2} - {n}_{2} cos {θ}_{3}}{{n}_{3} cos {θ}_{2} + {n}_{2} cos {θ}_{3}} \\ C = \frac{{n}_{1} cos {θ}_{1} - {n}_{2} cos {θ}_{2}}{{n}_{1} cos {θ}_{1} + {n}_{2} cos {θ}_{2}} D = \frac{{n}_{2} cos {θ}_{2} - {n}_{3} cos {θ}_{3}}{{n}_{2} cos {θ}_{2} + {n}_{3} cos {θ}_{3}} \\ δ = \frac{2 π {n}_{2} d cos {θ}_{2}}{λ} \qquad [ Formula 1 ]$$

In the expression, λ is a main wavelength of light irradiated from the light source unit of the photosensor and can be set to 730 nm, for example.

n₁ is a refractive index of air and is generally 1.00 which is the substantially same as that in the vacuum.

θ₁ is an incident angle when the irradiation light from the light source unit of the photosensor is incident on an interface between the uppermost surface thin film layer 3b and the air from the air side and is generally in the range of 0 to 90°.

n₂ is a refractive index of the uppermost surface thin film layer 3b and is generally in the range of 1 to 4.

θ₂ is an incident angle when the irradiation light from the light source unit of the photosensor is incident on an interface between the substrate 3a and the uppermost surface thin film layer 3b from the uppermost surface thin film layer 2b side and is generally in the range of 0 to 90°.

n₃ is a refractive index of the substrate 3a and is in the range of 1 to 4.

θ₃ is an incident angle when the irradiation light from the light source unit of the photosensor is incident on an interface between the air and the substrate 3a from the substrate 3a side and is generally in the range of 0 to 90°.

d is the thickness of the uppermost surface thin film layer 3b as described above.

When the intermediate transfer belt has a multilayer structure in which a specific thin film layer 3c and the uppermost surface thin film layer 3b are sequentially formed on the substrate 3a, the reflectivity function R(d) can be obtained by a calculation using the known matrix method. In this case, the thickness d of the uppermost surface thin film layer 3b is set such that the R(d) satisfies the above conditional expression while a thickness of the thin film layer 3c is assumed to be a fixed value. The thin film layer 3c may be formed with two or more layers.

The uppermost surface thin film layer 3b having the thick film region 31 and the thin film region 32 in the first and second aspects of the invention can be formed by stopping rotation of a roll electrode during deposition or masking a predetermined thin film region with a plasma CVD method, in particular, an atmospheric pressure plasma CVD method. In the plasma CVD method, a mixed gas of at least discharge gas and raw gas for an inorganic oxide layer is made to be a plasma state so as to deposit and form a film in accordance with the raw gas. In the atmospheric pressure plasma CVD method, operations in the plasma CVD method are performed under an atmospheric pressure or an pressure near the atmospheric pressure. A resin film such as a PET can be used as the mask. The plasma CVD method can be performed in accordance with a method as described in JP-A-No. 2007-17666.

Hereinafter, an apparatus and a method of manufacturing the uppermost surface thin film layer 3b are described by exemplifying a case where an inorganic oxide layer containing silicon oxide (SiO₂) is formed with the atmospheric pressure plasma CVD method. The atmospheric pressure and the pressure near the atmospheric pressure are in the range of 20 kPa to 110 kPa, and preferably in the range of 93 kPa to 104 kPa.

FIG. 12 is a view explaining an apparatus of manufacturing the inorganic oxide layer. The manufacturing apparatus 40 of the inorganic oxide layer forms the inorganic oxide layer on the substrate by a direct method in which the discharge space and the thin film deposition region are the substantially same portion and the thin film is formed and deposited by exposing the substrate to the plasma. The manufacturing apparatus 40 includes: a roll electrode 50 around which an endless belt substrate 3a is wound and stretched and which rotates in the direction of an arrow; a driven roller 60; and an atmospheric pressure plasma CVD device 70 which is a film formation device for forming the inorganic oxide layer on the surface of the substrate.

The atmospheric pressure plasma CVD device 70 has at least one set of fixed electrodes 71, a discharge space 73, a mixed gas supply device 74, a discharge container 79, a first power source 75, a second power source 76 and an exhaust unit 78. The fixed electrodes 71 are arranged along an outer circumference of the roll electrode 50. The discharge space 73 is a facing region between the fixed electrode 71 and the roll electrode 50 and performs discharging. The mixed gas supply device 74 generates a mixed gas G of at least raw gas and discharge gas so as to supply the mixed gas G to the discharge space 73. The discharge container 79 reduces air flow into the discharge space 73 and the like. The first power source 75 is connected to the fixed electrode 71. The second power source 76 is connected to the roll electrode 50. The exhaust unit 78 exhausts exhaust gas G′ which has been used. The second power source 76 may be connected to the fixed electrode 71 and the first power source 75 may be connected to the roll electrode 50.

The mixed gas supply device 74 supplies mixed gas in which raw gas forming a film containing the silicon oxide and noble gas such as nitrogen gas or argon gas are mixed to the discharge space 73.

The driven roller 60 is biased by tension biasing means 61 in the direction of an arrow and applies a predetermined tension to the substrate 3a. The tension biasing means 61 releases the biasing of tension at the time of replacing the substrate 3a so as to make it possible to easily replace the substrate 3a.

The first power source 75 outputs a voltage having a frequency ω1 and the second power source 76 outputs a voltage having a frequency ω2 which is higher than the frequency ω1. These voltages generate an electric field V in which the frequencies ω1 and ω2 are superimposed in the discharge space 73. Then, the mixed gas G is made to be a plasma state with the generated electric field V so that a film (inorganic oxide layer) in accordance to the raw gas contained in the mixed gas G is deposited on the surface of the substrate 3a.

If a predetermined thickness is realized in the thin film region when the inorganic oxide layer is formed as described above, a predetermined thin film region are masked. Then, the deposition of the inorganic oxide is continued until a predetermined thickness is realized in the thick film region.

When a silicon oxide layer is formed, tetraethoxysilane (TEOS), tetramethoxysilane (TMOS), tetrachlorosilane, or the like can be used as the raw gas. When an aluminum oxide layer is formed, aluminum chloride, trimethylaluminium, triethoxyaluminium, trimethoxyaluminium, and the like can be used as the raw gas. When a titanium oxide layer is formed, titanium chloride, tetramethoxytitanium, tetraethoxytitanium, and the like can be used. When the zinc oxide layer is formed, diethoxyzinc and zinc chloride, and the like can be used.

### EXAMPLES

### Experimental Example A

### Manufacturing of Intermediate Transfer Belt

A seamless-shape substrate having a surface resistance of 1.30 10⁹Ω/□, a thickness of 120 μm, and a circumferential length of 700 nm was obtained by dispersing carbon in a PPS resin by extrusion molding.

A SiO₂ thin film layer (hardness: 4 GPa, surface roughness Ra: 31 nm) having a predetermined thickness was formed on the outer circumferential surface of the substrate by the apparatus shown in FIG. 12 based on the atmospheric pressure plasma CVD method so as to obtain an intermediate transfer belt.

Evaluation

The intermediate transfer belt manufactured by the above method was mounted on a printer (Bizhub C353: manufactured by KONICA MINOLTA HOLDINGS, INC.) and a solid image was printed on a J paper (A4 size) which is also manufactured by KONICA MINOLTA HOLDINGS, INC. A secondary transfer ratio (%) onto the paper transferred from the intermediate transfer belt was obtained. The secondary transfer ratio is a percentage of a toner weight of the solid image which is secondarily transferred with respect to a toner weight of the solid image on the intermediate transfer belt. The printing condition was the same as standard conditions of the above printer except that the intermediate transfer belt was used. A polymerization toner having an average particle size of 6.5 μm was used for the toner. As a comparison, the seamless-shap substrate was used as the intermediate transfer belt for evaluation.

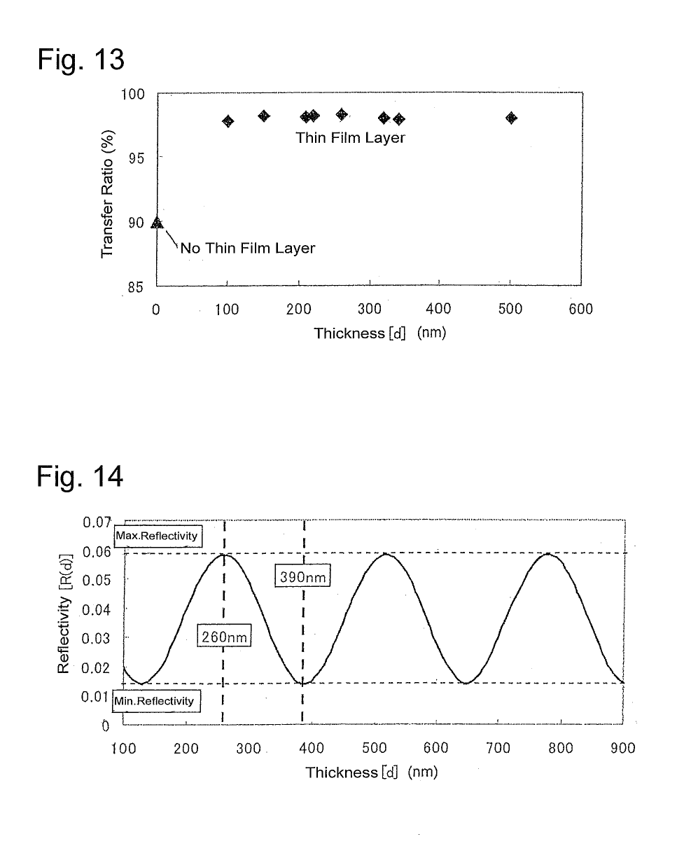

A relationship between the transfer ratio and the film thickness is shown in FIG. 13. As shown in FIG. 13, the transfer ratio was improved by providing the inorganic oxide thin film layer on the substrate and the transfer ratio was not significantly changed depending on the film thickness. Therefore, the film thickness of the thin film layer can be set to an arbitrary thickness without affecting the transfer quality.

### Experimental Example B

The following calculation conditions were substituted into the above reflectivity function R(d) in the case where the intermediate transfer belt had a single layer structure in which one uppermost surface thin film layer (SiO₂) was formed on the substrate. The obtained function is shown in a graph of FIG. 14. FIG. 14 shows that if the thickness d₁ (nm) of the thick film region is set to 390 nm and the thickness d₂ (nm) of the thin film region is set to 260 nm in the intermediate transfer belt, a difference in reflectivity between the regions thereof becomes a maximum value.

Calculation Condition

Substrate refractive index (n₃): 1.65 (polyphenylene sulfide: PPS)

Substrate thickness: 150 μm

Thin film layer refractive index (n₂): 1.45 (SiO₂)

Incident angle on thin film layer (θ₁): 20°

Light-emitting main wavelength (λ): 730 nm

Air layer refractive index (n₁): 1

Incident angle on substrate (θ₂): 13.6°

Incident angle (θ₃): 12.0°

### Experimental Example C

An intermediate transfer belt having a single layer structure in which one uppermost surface thin film layer (SiO₂) was formed on the substrate was manufactured. In the intermediate transfer belt, the uppermost surface thin film layer has the thick film region 31 and the thin film region 32 in the circumferential direction. Detail arrangements of the thick film region 31 and the thin film region 32 on the uppermost surface thin film layer are shown in FIG. 6 and the thick film region 31 was formed in the thin film region 32 over the whole length in the width direction W. The thickness d₁ of the thick film region 31 was 390 nm, the circumferential length of the thick film region 31 was 10 mm and the thickness d₂ of the thin film region was 260 nm.

Such a method of manufacturing the intermediate transfer belt was the same as the method of manufacturing the intermediate transfer belt in the experimental example A except for the following point. The point is that when a predetermined thickness of the thin film region was realized at the time of forming the SiO₂ layer, the rotation of the roll electrode of the film formation device was stopped and deposition of SiO₂ was continued until a predetermined thickness of the thick film region was realized. The change in film thickness of the obtained intermediate transfer belt in the belt circumferential direction is shown in FIG. 7.

Evaluation

The obtained intermediate transfer belt and the photosensor were mounted on a printer. The printer was obtained by customizing Bizhub C353 (manufactured by KONICA MINOLTA HOLDINGS, INC.). The customized printer has a schematic configuration as shown in FIG. 4. The photosensor 20 was arranged at one edge portion in the width direction W of intermediate transfer belt 3, as shown in FIG. 6.

Irradiation conditions of the photosensor are shown as follows.

Incident angle on thin film layer θ₁: 20°
Light-emitting main wavelength: 730 nm

Change in sensor output in the belt circumferential direction was measured by rotation-driving the intermediate transfer belt while driving the photosensor. The result is shown in FIG. 8. A home position in the circumferential direction of the intermediate transfer belt could be detected by measuring the change in sensor output in this manner.

### Experimental Example D

An intermediate transfer belt having a single layer structure in which one uppermost surface thin film layer (SiO₂) was formed on the substrate was manufactured. In the intermediate transfer belt, the uppermost surface thin film layer has the thick film region 31 and the thin film region 32. Detail arrangements of the thick film region 31 and the thin film region 32 on the uppermost surface thin film layer are shown in FIG. 3 and a character image “DO NOT TOUCH” was formed with the thick film region 31 in the thin film region 32. The thickness d₁ of the thick film region 31 was 390 nm and the thickness d₂ of the thin film region was 260 nm.

Such a method of manufacturing the intermediate transfer belt was the same as the method of manufacturing the intermediate transfer belt in the experimental example A except for the following point. The point is that when a predetermined thickness of the thin film region was realized at the time of forming the SiO₂ layer, the predetermined thin film region was masked and deposition of SiO₂ was continued until a predetermined thickness of the thick film region is realized.

When the outer circumferential surface of the obtained intermediate transfer belt was visually observed under natural light, a predetermined character image could be recognized.

Evaluation

The obtained intermediate transfer belt was mounted on a printer (Bizhub C353: manufactured by KONICA MINOLTA HOLDINGS, INC.) and a half tone image was printed on a J paper (A4 size) which is also manufactured by KONICA MINOLTA HOLDINGS, INC. The printing conditions were the same as the standard conditions of the above printer except that the above intermediate transfer belt was used. A polymerization toner having an average particle size of 6.5 μm was used for the toner.

When the printed image was visually observed, a half tone image without hollows and uneven images could be obtained.

According to a first aspect of the invention, there is provided an image-supporting member having at least one thin film layer on an outer circumferential surface of the image-supporting member, characterized in that an uppermost surface thin film layer has a thick film region and a thin film region, a predetermined image is formed by the thick film region and the thin film region, and a thickness d₁ (nm) of the thick film region and a thickness d₂ (nm) of the thin film region satisfy the following relational expressions (1) and (2);

50 nm≦d₁−d₂≦950 nm (1)

20 nm≦d₂<d₁≦1000 nm (2), and

an image-forming apparatus including the image-supporting member.

According to a second aspect of the invention, there is provided an image-forming apparatus including

an image-supporting member having at least one thin film layer on an outer circumferential surface of the image-supporting member, in which an uppermost surface thin film layer has a thick film region and a thin film region, a predetermined image is formed by the thick film region and the thin film region, and a thickness d₁ (nm) of the thick film region and a thickness d₂ (nm) of the thin film region satisfy the following relational expressions (1) and (2):

50 nm≦d₁−d₂≦950 nm (1)

20 nm≦d₂<d₁≦1000 nm (2); and

a photosensor which includes a light source unit having a light-emitting main wavelength λ and irradiating the outer circumferential surface of the image-supporting member with light and a light receiving unit receiving reflection light reflected on the outer circumferential surface of the image-supporting member, and

optically detects a reflectivity of the outer circumferential surface of the image-supporting member,

wherein the thickness d₁ (nm) of the thick film region and the thickness d₂ (nm) of the thin film region further satisfy the following relational expression (3) for a reflective function R(d) indicating a relationship between a reflectivity R of the outer circumferencial surface of the image-supporting member with respect to light having a light-emitting main wavelength λ from the light source unit and a thickness d (nm) of the uppermost surface thin film layer of the image-supporting member:

|R(d₁)−R(d₂)|≧0.5{Rₘₐₓ(d)−Rₘᵢₙ(d)} (3).

Effect of the Invention

In the image-supporting member according to the first aspect of the invention, there is little difference in toner image-transferring property between the thick film region and the thin film region so that a toner image on the recording medium is not adversely affected. Therefore, both the thick film region and the thin film region can be mixedly formed on the outer circumferential surface. In addition, the reflectivity with respect to natural light becomes different between the thick film region and the thin film region based on the difference in thickness. This makes it possible to visually distinguish the thick film region and the thin film region from each other. Therefore, the toner image formed on a recording medium such as a paper sheet is not adversely affected even though an image such as a character or a symbol (emboss image) is formed in the thin film region or in the thick film region on an image-supporting surface (uppermost surface thin film layer). Accordingly, printed matters are not required to be pasted if indications such as instructions for use, symbols and product numbers are displayed by the thick film region and the thin film region as emboss images. Further, the thick film region and the thin film region are formed on the image-transporting surface which is always cleaned by the cleaning member for collecting remaining toners after transferred. Therefore, the indications can be continuously displayed for a long period of time easily.

In the image-forming apparatus according to the second aspect of the invention, the image-supporting member is an image-supporting member according to the first aspect of the invention in which the thickness of the thick film region and the thickness of the thin film region further satisfy a predetermined relational expression (relational expression (3)). Therefore, in the image-forming apparatus according to the second aspect of the invention, the following effects can be obtained in addition to the effects obtained in the first aspect of the invention.

A home position and a rotational speed of the image-supporting member can be stably detected without increasing the apparatus in size by detecting the thick film region and the thin film region at known positions in the circumferential direction by the photosensor. In addition, a conventionally used photosensor for correcting concentrations of toner can be used as the photosensor so that a dedicated sensor is not required to be newly provided. Further, the thick film region and the thin film region are formed on the image-transporting surface which is always cleaned by the cleaning member for collecting the remaining toners after transferred. Accordingly, there is no risk that the detection accuracy is deteriorated due to toner powder smokes.

What is claimed is:

1. An image-supporting member, comprising at least one thin film layer on an outer circumferential surface of the image-supporting member,
wherein an uppermost surface thin film layer comprises a thick film region and a thin film region, a predetermined image is formed by the thick film region and the thin film region, and a thickness d₁ (nm) of the thick film region and a thickness d₂ (nm) of the thin film region satisfy the following relational expressions (1) and (2);
50 nm≦d₁−d₂≦950 nm (1)
20 nm≦d₂<d₁≦1000 nm (2)

2. The image-supporting member according to claim 1,
wherein the uppermost surface thin film layer is an inorganic oxide layer.

3. The image-supporting member according to claim 2,
wherein the inorganic oxide layer is a layer comprising one or more oxides selected from the group consisting of silicon oxide, aluminum oxide, titanium oxide and zinc oxide.

4. The image-supporting member according to claim 1,
wherein the image-supporting member is an intermediate transfer member or a photosensitive member, having a belt shape or a drum shape.

5. An image-forming apparatus, comprising an image-supporting member wherein the image-supporting member comprises at least one thin film layer on an outer circumferential surface of the image-supporting member,
an uppermost surface thin film layer comprises a thick film region and a thin film region,
a predetermined image is formed by the thick film region and the thin film region, and
a thickness d₁ (nm) of the thick film region and a thickness d₂ (nm) of the thin film region satisfy the following relational expressions (1) and (2);
50 nm≦d₁−d₂≦950 nm (1)
20 nm≦d₂<d₁≦1000 nm (2)

6. The image-forming apparatus according to claim 5,
wherein the uppermost surface thin film layer is an inorganic oxide layer.

7. The image-forming apparatus according to claim 6,
wherein the inorganic oxide layer is a layer comprising one or more oxides selected from the group consisting of silicon oxide, aluminum oxide, titanium oxide and zinc oxide.

8. The image-forming apparatus according to claim 5,
wherein the image-supporting member is an intermediate transfer member or a photosensitive member, having a belt shape or a drum shape.

9. An image-forming apparatus according to claim 5, further comprising a photosensor,
wherein the photosensor comprises a light source unit for emitting a light having a main wavelength λ and irradiating the outer circumferential surface of the image-supporting member with the light and a light receiving unit for receiving reflection light reflected on the outer circumferential surface of the image-supporting member, and optically detects a reflectivity on the outer circumferential surface of the image-supporting member,
wherein a thickness d₁ (nm) of the thick film region and a thickness d₂ (nm) of the thin film region satisfy the following relational expression (3) for the reflective function R(d) indicating a relationship between a reflectivity R on the outer circumferencial surface of the image-supporting member with respect to the light having a light-emitting main wavelength λ from the light source unit and a thickness d (nm) of the uppermost surface thin film layer of the image-supporting member:

|R(d₁)−R(d₂)|≧0.5{Rₘₐₓ(d)−Rₘᵢₙ(d)} (3).

10. The image-forming apparatus according to claim 9,
wherein the uppermost surface thin film layer of the image-supporting member comprises a thick film region and a thin film region in the circumferential direction of the image-supporting member, and the thick film region and the thin film region at predetermined positions in the circumferential direction are detected by the photosensor based on a difference in reflectivity between the thick film region and the thin film region.
